(19) United States
(12) Patent Application Publication
(10) Pub. No.: US 2016/0065992 A1
(43) Pub. Date: Mar. 3, 2016

(54) EXPORTING ANIMATIONS FROM A PRESENTATION SYSTEM

(71) Applicant: Microsoft Technology Licensing, LLC, Redmond, WA (US)

(72) Inventor: Om Krishna, Redmond, WA (US)

(21) Appl. No.: 14/470,587

(22) Filed: Aug. 27, 2014

(51) Int. Cl. H04N 19/70; G06T 13/00

(52) U.S. Cl. CPC H04N 19/70; G06T 13/00

(57) ABSTRACT

A user input mechanism is displayed within a presentation system that allows a user to specify a certain portion of a selected slide (in a slide presentation), that has animations applied to it, that is to be exported in a selected export format. Information describing the specified portion of the selected slide, and information describing the animations applied to that portion, is obtained. An export file is generated with the specified portions of the slide, and the corresponding animations, in the selected export format.

### BACKGROUND

Computer systems are currently in wide user. Many computer systems run presentation systems that allow a user to author, and edit, presentation content.

Some presentation systems include slide presentation systems. These types of systems can provide a relatively easy way to build powerful animations. The animations can help explain complex concepts, easily, and they can help an audience understand ideas more visually. Some users that generate presentations, with animations, use other types of computer systems for generating other content as well, such as blogs, webpages, etc. Such users sometimes recreate the animations previously created in the presentation system, so that the animations can be presented in the other environments (such as on blogs, webpages, etc.).

In order to recreate the animations, many users have attempted to do so using animation software that uses a file format that can be used to generate animated films, animated cartoons, etc. One example of such a file format is the .swf file format that can be generated using flash animation. These types of animation mechanisms, however, can be relatively complex. For instance, they can integrate bitmaps and other raster-based art, as well as video, and vector-based drawings. Using flash-based animation software can be rather difficult, and can require special expertise on the part of the user, in order to use such software effectively.

The discussion above is merely provided for general background information and is not intended to be used as an aid in determining the scope of the claimed subject matter.

### SUMMARY

A user input mechanism is displayed within a presentation system that allows a user to specify a certain portion of a selected slide (in a slide presentation), that has animations applied to it, that is to be exported in a selected export format. Information describing the specified portion of the selected slide, and information describing the animations applied to that portion, is obtained. An export file is generated with the specified portions of the slide, and the corresponding animations, in the selected export format.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a presentation system architecture.

FIG. 2 is a block diagram of one example of a slide with a plurality of different objects and animations disposed thereon.

FIGS. 3A and 3B (collectively referred to as FIG. 3) show one example of the operation of the architecture illustrated in FIG. 1, in allowing a user to export an animated portion of a slide to a desired export format.

FIG. 4 shows one example of a user interface display.

FIG. 5 is a block diagram showing one example of the architecture shown in FIG. 1, deployed in a cloud computing architecture.

FIGS. 6-8 show examples of mobile devices.

FIG. 9 is a block diagram of on illustrative computing environment.

### DETAILED DESCRIPTION

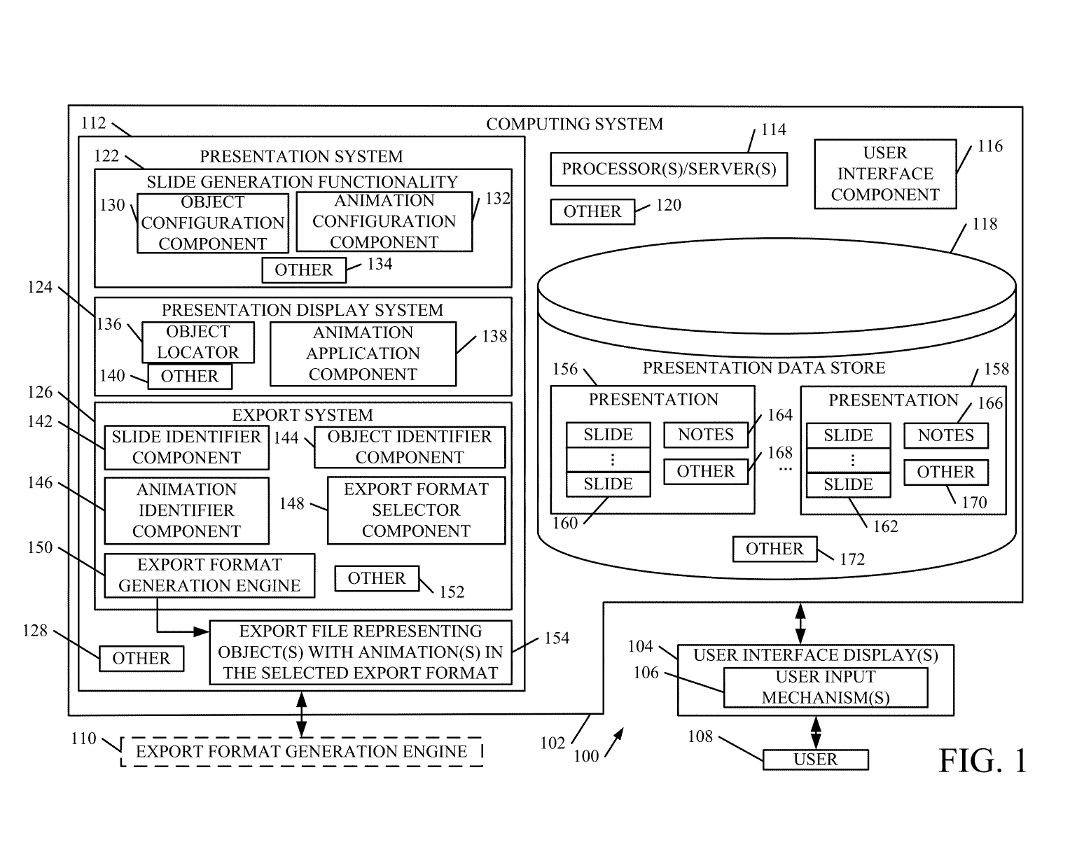

FIG. 1 is a block diagram of one example of a presentation system architecture 100. Architecture 100 illustratively includes computing system 102 that generates user interface displays 104 with user input mechanisms 106 for interaction by user 108. FIG. 1 also shows an example in which computing system 102 can have access to one or more export format generation engines 110.

In the example shown in FIG. 1, computing system 102 illustratively includes presentation system 112, processors or servers 114, user interface component 116, presentation data store 118, and it can include other items 120 as well. Presentation system 112 illustratively includes slide generation functionality 122, presentation display system 124, export system 126, and it can include other items 128. Slide generation functionality 122 includes object configuration component 130, animation configuration component 132 and it can include other items 134. Presentation display system 124 includes object locator 136, animation application component 138, and it can include other items 140. Export system 126 illustratively includes slide identifier component 142, object identifier component 144, animation identifier component 146, export format selector component 148, export format generation engine 150, and it can include other items 152.

The example shown in FIG. 1 also illustrates that presentation data store 118 is part of computing system 102. It can be used to store a plurality of different slide presentations 156-158, once they are authored using presentation system 112. Each presentation 156-158 illustratively includes a plurality of different slides 160-162. The slides can have corresponding notes 164-166, and the presentations can include other items 168-170. Of course, presentation data store 118 can store other items 172 as well. It will be noted that presentation data store 118, while it is shown external to presentation system 112 but within computing system 102, can be located elsewhere. For instance, it can be external to computing system 102 and accessed by system 102. Alternately, it can internal to presentation system 112. Similarly, it can be divided in which case some portions of data store 118 are external to system 102 while others are internal to system 102. All of these architectures are contemplated herein.

In one example, user 108 interacts with user input mechanisms 106 on user interface displays 104 in order to access slide generation functionality 122 in order to generate slides for a slide presentation. Presentation display system 124 can be accessed in order to present slides or make presentations using previously-created slides.

Export system 126 illustratively generates user interface displays 104 with user input mechanisms 106 that allow user 108 to identify certain objects within one or more slides in a previously-created slide presentation, in order to have those objects and their corresponding animations converted into an animation file format that is independent of presentation system 112. For instance, in one example, the format is one that is compatible with browsers, other presentation players, animation players, or a wide variety of other external systems. For instance, the format can be in a graphics file format, such as graphics interchange format (GIF), a video or movie format, or other formats that can be used external to presentation system 112 in order to play the exported animations.

For purposes of the present discussion, animated transitions are animations that appear when a user switches from one slide to another in a slide presentation. Animated page elements are moving images or expanding or contracting images on a slide within the presentation. The term “animations”, as used herein, will illustratively include both animated transitions and animated page elements.

Before describing the overall operation of system 102 in allowing a user to generate animations, a brief overview of some of the components of system 102 will first be provided. Slide generation functionality 122 illustratively includes the functionality that is used by user 108 to generate, edit, or otherwise modify a slide presentation. In the example shown in FIG. 1, it includes object configuration component 130, animation configuration component 132, and it can include other items 134 as well. Object configuration component 130 includes functionality that allows user 108 to select or otherwise define objects that are to be placed at a given location on a slide. Animation configuration component 132 includes functionality that generates user interface displays with user input mechanisms that can be actuated by user 108 in order to apply animations to the objects that are located on the slide, or to the transitions between slides, or other animations.

Presentation display system 124 is used to display or present slide presentations that have already been created. They illustratively include object locator 136, animation application component 138, and they can include other items 140 as well. Object locator 136 identifies the objects on a given slide and their locations, where they are to appear, on the slide Animation application component 138 identifies any animations that are to be applied to the objects identified by object locator 136, on the slide. By way of example, an object located by object locator 136 may be a gear wheel that is to be positioned at the center of the corresponding slide. The animation may be to rotate the gear wheel at a given speed at the center of the slide. Thus, object locator 136 locates the gear wheel object on the center of the slide, and animation application component 138 applies the “rotate” animation to the gear wheel.

System 126 illustratively allows user 108 to select a given subset of the objects on a selected slide, and their corresponding animations, for export to a desired export format. Slide identifier component 142 illustratively generates user interface displays with user input mechanisms that can be actuated by user 108 in order to identify a slide in a slide presentation, from which objects are to be exported. Object identifier component 144 illustratively identifies the various objects on the selected slide and generates user input mechanisms that allow user 108 to select objects on the slide for export. Animation identifier component 146 illustratively identifies any animations corresponding to the selected objects. Form export format selector component 148 illustratively generates user interface displays with user input mechanisms that can be actuated by user 108 in order to allow user 108 to select a particular export format for the selected objects and their corresponding animations. Export format generation engine 150 illustratively generates user interface displays with user input mechanisms that can be actuated by user 108 in order to provide any further export configuration information. By way of example, they may allow user 108 to identify a particular frame rate for the animation. They may also be used to identify any compression techniques that the user wishes to have deployed. They can be used to identify other configuration inputs as well. Engine 150 then illustratively generates an export file 154 that represents the objects with the corresponding animations in the selected export format. Engine 150 can then save the export file 154 for use by, or export to, another system.

As briefly mentioned above, any of the elements in presentation system 112 can be external elements and accessed by presentation system 112. In the example shown in FIG. 1, export format generation engine 110 (or a plurality of different engines 110) can be external to system 112 and accessed by system 112, depending upon the particular export format selected by the user. Of course, this is an example only and other components of system 112 can be external to system 112 and accessed by system 112, as well.

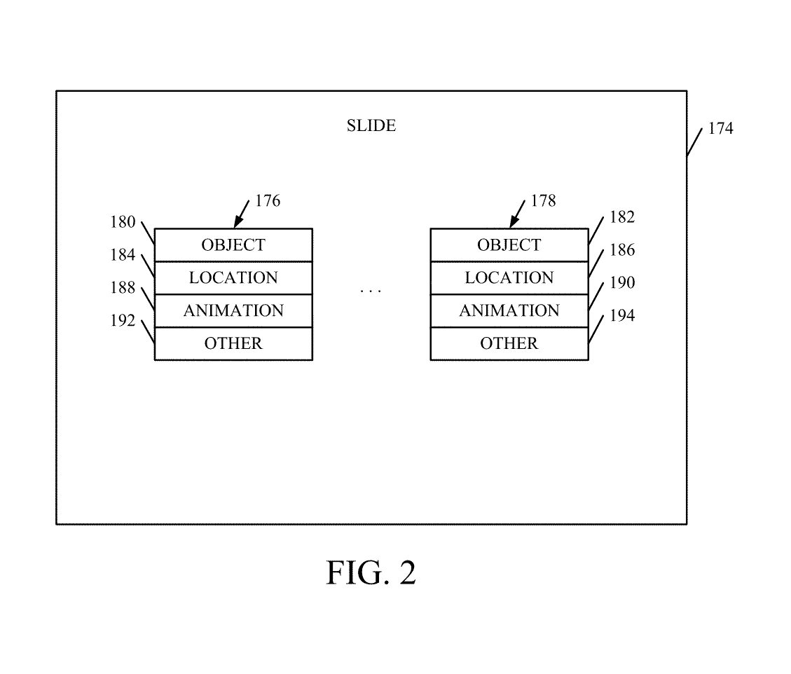

FIG. 2 shows one simplified example of a slide 174 that can be generated for use within a slide presentation 156-158. In the example shown in FIG. 2, slide 174 includes a plurality of objects 176-178, that appear on slide 174. Each object illustratively has object content 180-182 and corresponding location information 184-186 that specifies the location of the specified object on the slide 174. Each object can also include animation information 188-190 that specifies or otherwise identifies an animation that can be applied to the object identified by the object information 180-182. Of course, each object 176-178 can have other information associated with it, as indicated by blocks 192-194, respectively.

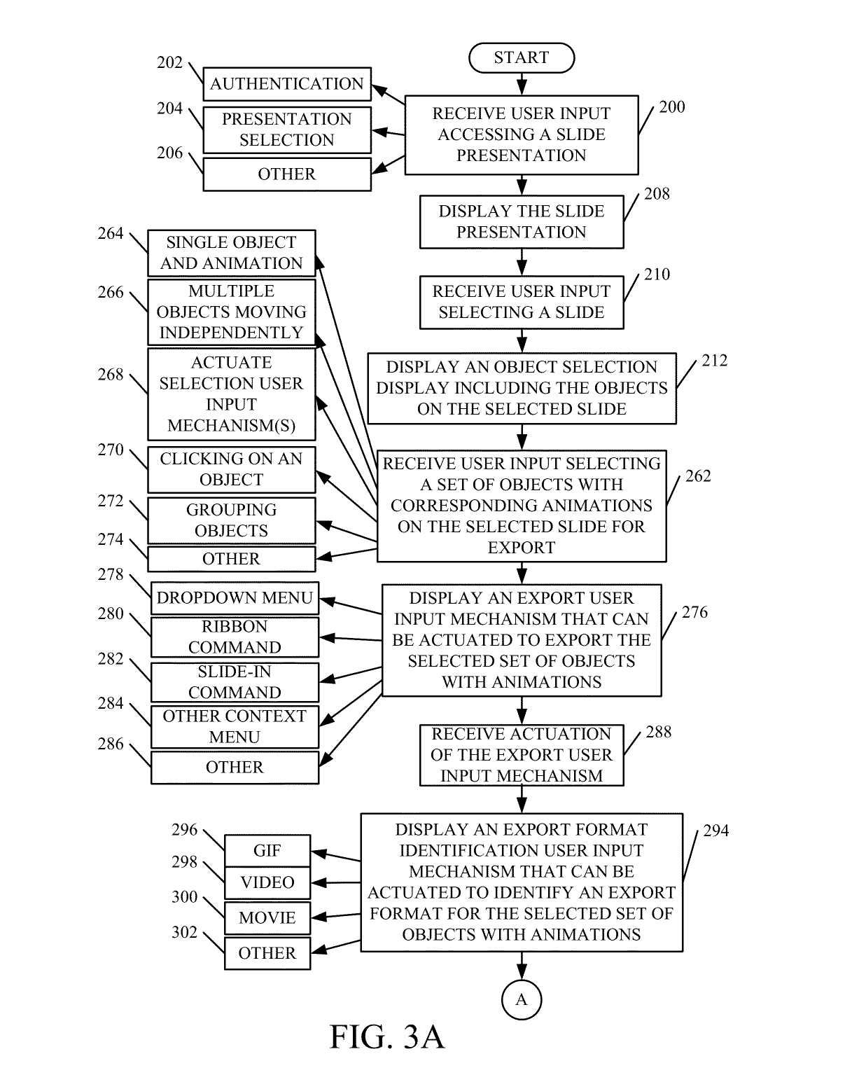

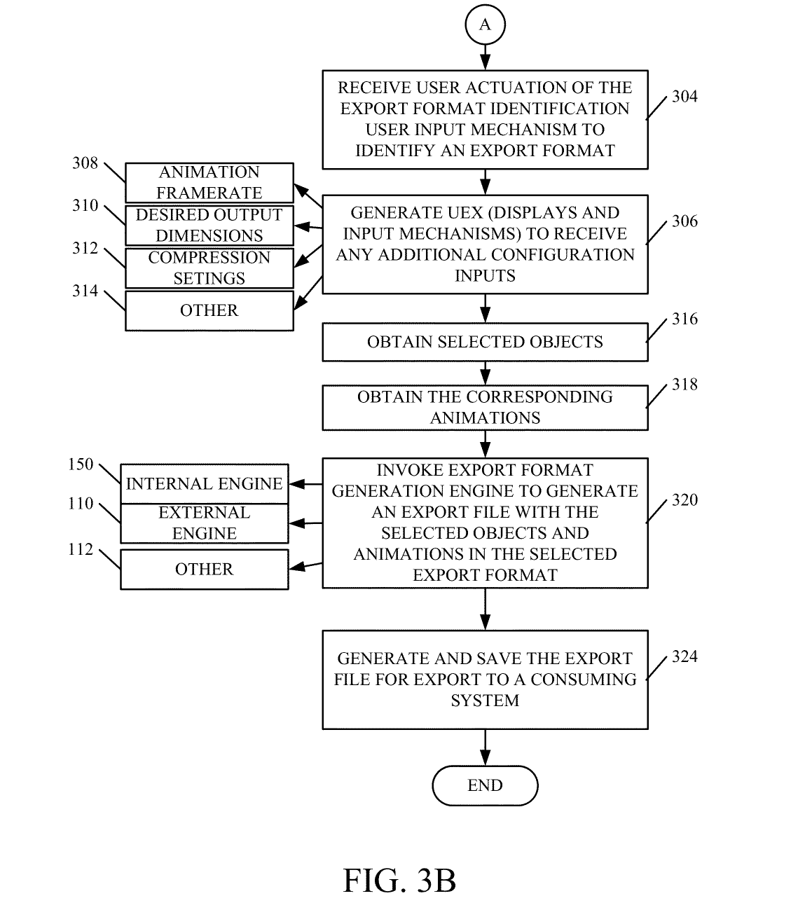

FIGS. 3A and 3B (collectively referred to herein as FIG. 3) show a flow diagram illustrating one example of the operation of export system 126 in allowing user 108 to export a selected portion of a given slide in accordance with a designated export format. It is assumed, in describing FIG. 3, that user 108 (or another user) has already generated at least one slide in a slide presentation, wherein the slide has one or more objects that have animations applied thereto. Again, as mentioned above, the animations include animated transitions, animations applied to objects, etc. Thus, presentation system 112 first receives user input from user 108 accessing a slide presentation (such as presentation 156). This is indicated by block 200 in FIG. 3. By way of example, user 108 can do this by providing authentication information 202 to log in to the presentation system, a presentation selection input 204 selecting a given presentation (e.g., presentation 156) or by providing other inputs 206. In response, presentation system 112 accesses the identified slide presentation 156 and displays the slide presentation to user 108. This is indicated by block 208.

User 108 then accesses export system 126 within presentation system 112. Specifically, slide identifier component 142 receives a user input selecting a slide within the selected presentation 156 for export. Receiving the user inputs selecting a slide is indicated by block 210 in FIG. 3. Object identifier component 144 then displays an object selection display including the objects on the selected slide. This is indicated by block 212. By way of example, the object selection display may display all of the objects, in selectable form, on a given slide.

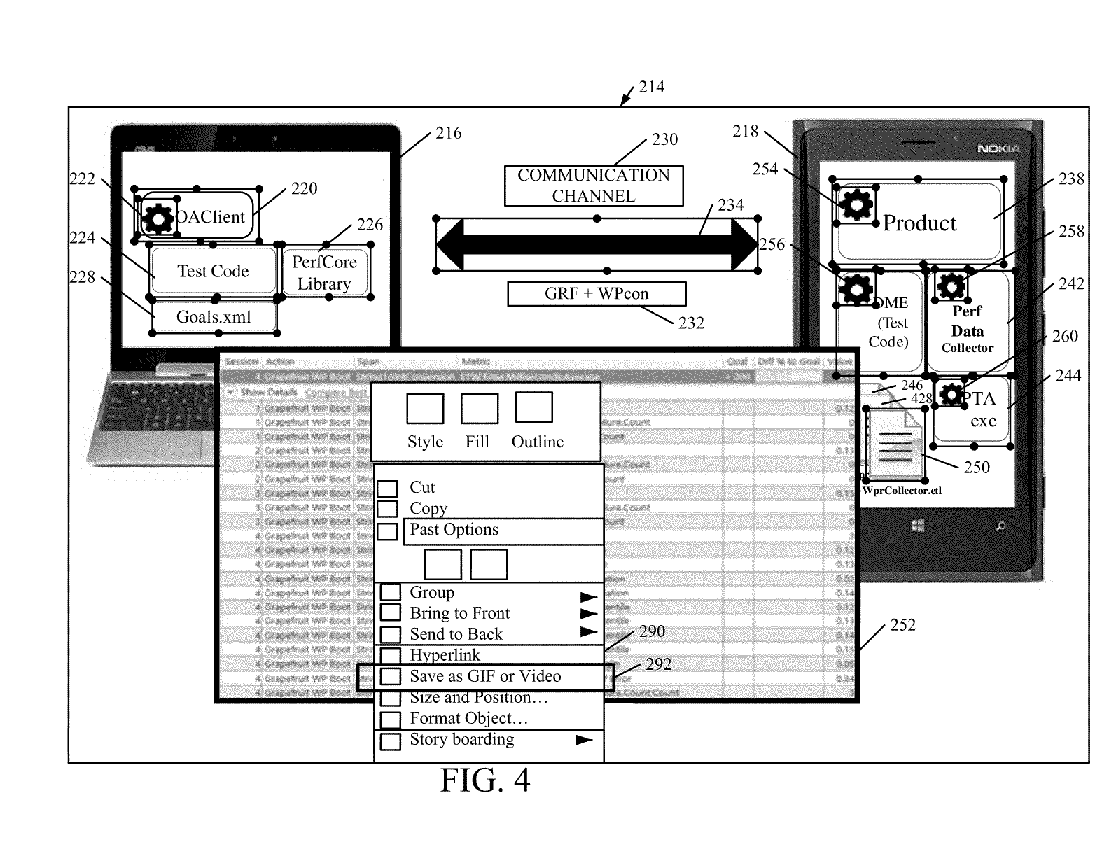

FIG. 4 shows one example of a user interface display 214 that indicates this. In FIG. 4, user interface display 214 corresponds to the display of the selected slide in slide presentation 256. It can be seen that the slide includes a plurality of different objects that are displayed on the slide. Object 216, for instance, is an image of a laptop computer. Object 218 is an image of smartphone. Object 220 is an image of an object displayed on top of object 216. Object 222 is an image of a gear wheel object that is displayed on top of object 220. By on top of, it is meant that object 222 is displayed within the bounds of the periphery of object 220, and covering a portion of object 220. Objects 224, 226 and 228 correspond to other objects that are displayed on top of object 216. Objects 230 and 232 correspond to textual objects which are text boxes that include displayed text. Object 234 is another object. Objects 238, 240, 242, 244, 246, 248 and 250 are all objects that are displayed on top of object 258. Object 252 is an object that is displayed across a plurality of different objects on user interface display 214.

Objects 254, 256, 258 and 260 are objects that are displayed on top of objects 238, 240, 242 and 244, respectively. Each of the objects 254-260 illustratively has a “rotate” animation applied to it as well. Therefore, when the slide is displayed in presentation mode, objects 254-260 are animated to rotate. Similarly, objects 246, 248 and 250 have movement animations applied to them. When they are displayed in presentation mode, they are animated to move across the slide from a position where they are displayed over cell phone object 218, to a position where they are displayed over laptop object 216. Thus, different objects on the slide have different animations so that they move independently of one another.

It can be seen in FIG. 4 that each of the objects 222-252 are displayed in selectable form. In the example shown, they are outlined by boxes to indicate that they are either already selected, or that they can be selected by having the user perform a simple user input option, such as hovering over an object, clicking on the object, touching it (on a touch sensitive screen), etc.

Once object identifier component 144 has displayed the objects selection display (such as the one shown in FIG. 4) it receives user inputs selecting a set of objects, with corresponding animations, on the selected slide, for export. This is indicated by block 262 in the flow diagram of FIG. 3. Again, this can be done in a wide variety of different ways. For instance, the user can select a single object and its corresponding animation (such as object 222 and its corresponding “rotate” animation). This is indicated by block 264 in FIG. 3. User 108 can also select a plurality of different objects, each of which have corresponding animations so that they move independently. This is indicated by block 266. The animations can be selected using a specific selection user input mechanism as indicated by block 268, or they can be selected when the object, itself, is selected. The object can be selected by tapping on the object or otherwise selecting the object, as indicated by block 270. Multiple objects can be selected at once by grouping objects together and then selecting the group, as indicated by block 272. The user can select objects for export in other was as well, and this indicated by block 274.

Animation identifier component 146 identifies the animations corresponding to the selected objects, and export format selector component 148 generates a user interface display with an export user input mechanism that can be actuated by user 108 in order to export the selected set of objects, with animations. This is indicated by block 276 in FIG. 3. The export user input mechanism can, for instance, be a drop down menu 278 that allows the user to actuate a particular user input mechanism to export the objects. It can be a ribbon command user input mechanism 280, it can be a command on a slide-in surface that is invoked when the user provides a certain gesture on the user interface display, as indicated by block 282, it can be another type of context menu 284, or it can be another user input mechanism 286. Export format selector component 148 then receives user actuation of the export user input mechanism as indicated by block 288 in FIG. 3.

FIG. 4 shows one example of this. For example, in FIG. 4, it is assumed that the user has selected all of the objects that are outlined on user interface display 214. The user can then illustratively right click on the screen, or otherwise invoke drop down menu 290. Drop down menu 290 includes a user input mechanism 292 that can be actuated by the user 108 in order to indicate that the user 108 wishes to export the selected objects as a GIF or video file.

Returning again to FIG. 3, when the user actuates user input mechanism 292, export format selector component 148 illustratively displays an export format identification user input mechanism that can be actuated by user 108 in order to identify a particular export format for the selected set of objects, with the corresponding animations. Specifying the particular format for export is indicated by block 294 in the flow diagram of FIG. 3. As examples, the format can be a GIF format 296, a video format 298, a movie format 300, or another type of animation-supporting format 302. In one example, the user can select particular browsers or other display mechanisms that the format should be compatible with. Of course, these are examples only. Export format selector component 148 then receives user actuation of the export format identification user input mechanism to identify the export format. This is indicated by block 304 in FIG. 3.

Depending on the particular type of export format selected by the user, export format selection component 148, or export format generation engine 150, can display user input mechanisms that prompt the user for additional export format configuration inputs. This is indicated by block 306 in FIG. 3. For instance, the user input mechanisms can ask the user 108 to select or otherwise specify an animation frame rate 308. It can ask the user to select or specify a desired output dimension for the format file, as indicated by block 310. It can ask the user to select or otherwise identify any other compression settings that identify compression mechanisms or algorithms that the user wishes to be applied to the export file. This is indicated by block 312. It can prompt the user for other export format configuration inputs as well, and this is indicated by block 314.

Once the configuration inputs are received, the export format selector component 148 retrieves the information describing the selected objects, along with the information describing the corresponding animations. The information can, for example, be the object information 180 shown in FIG. 2, along with the location information 184, the animation information 188, and the other information 192. These are examples only. Obtaining the information for the selected objects and the corresponding animations is indicated by blocks 316 and 318 in FIG. 3.

Export format selector component 148 then invokes an export format generation engine, corresponding to the selected export format, to generate the export files with the selected objects and corresponding animations in the selected export format. This is indicated by block 320 in FIG. 3. Again, as briefly discussed above, the export format generation engine 150 can be an internal engine 150, an external engine 110, or it can be another engine 112. The engine generates the export file representing the selected objects with corresponding animations, in the selected export format, and saves export file 154 for export to, or access by, a consuming system. This is indicated by block 324 in FIG. 3.

It can thus be seen that a user can quickly and easily generate powerful animations using built-in animation mechanisms in presentation system 112. However, user 108 can also export those animations in a presentation system-independent format that can easily be used by browsers, on blogs, in websites, or in other environments. This saves a significant amount of time and improves the operation of computing system 102. System 102 need not support a different type of animation generator (such as a flash animation system), and this thus reduces the amount of computing overhead that is used by system 102. Further, it greatly increases the efficiency and productivity of user 108. User 108 need not learn two separate animation systems, but instead only needs to learn the animation system for presentation system 112. The animations, once created, can easily be exported into other formats for use in other environments.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

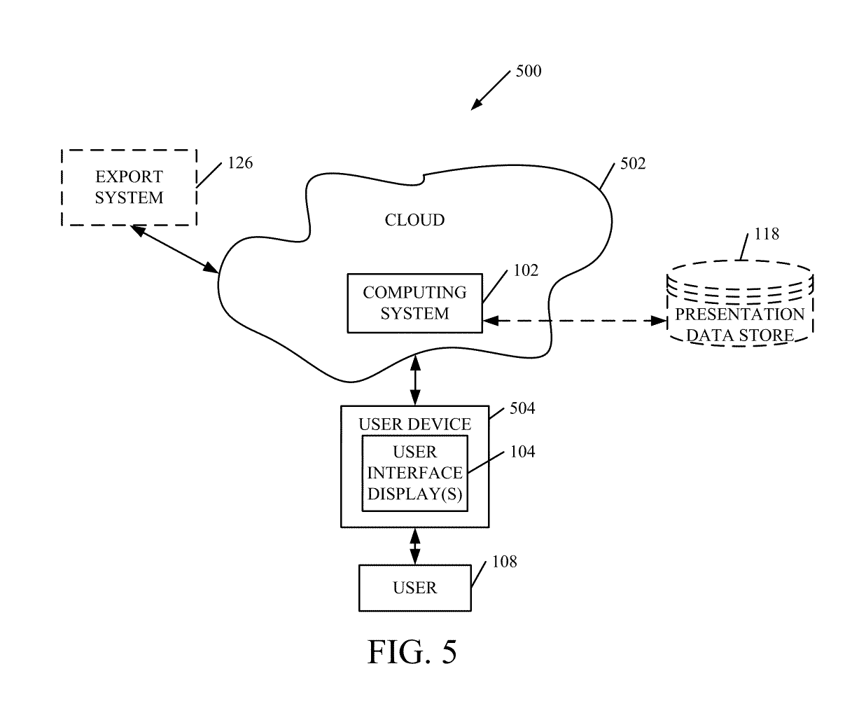

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that computing system 102 is located in cloud 502 (which can be public, private, or a combination where portions are public while others are private). Therefore, user 108 uses a user device 504 to access those systems through cloud 502.

FIG. 5 also depicts another example of a cloud architecture. FIG. 5 shows that it is also contemplated that some elements of system 102 can be disposed in cloud 502 while others are not. By way of example, data store 118 can be disposed outside of cloud 502, and accessed through cloud 502. In another example, export system 126 can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

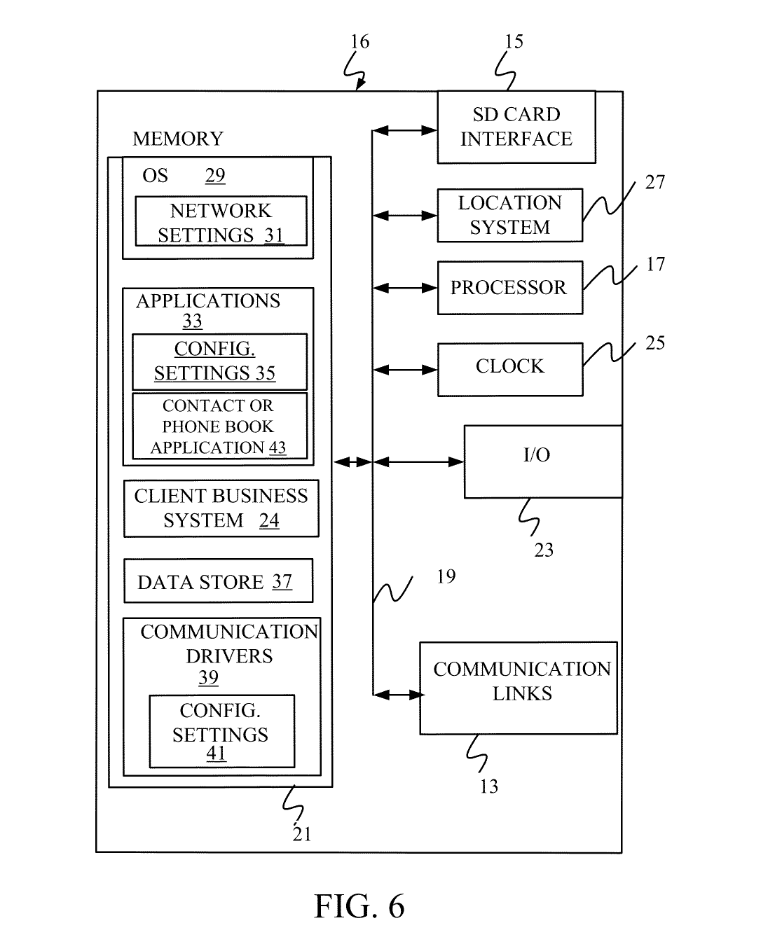

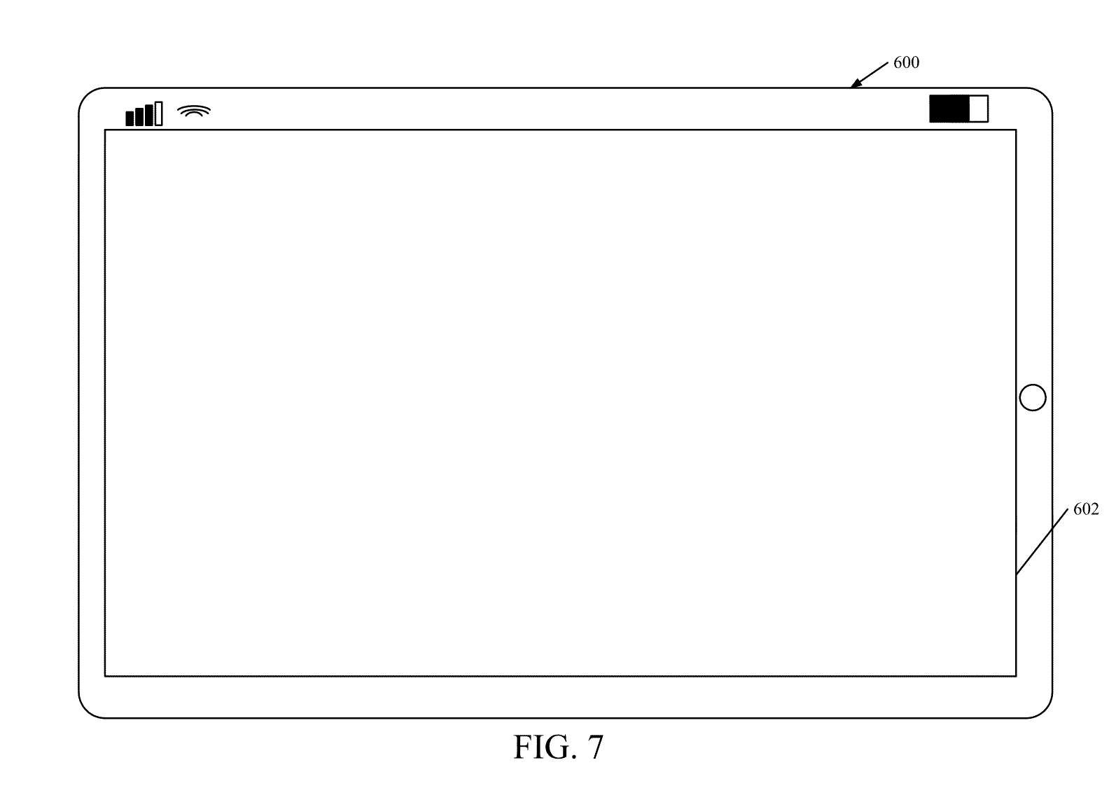

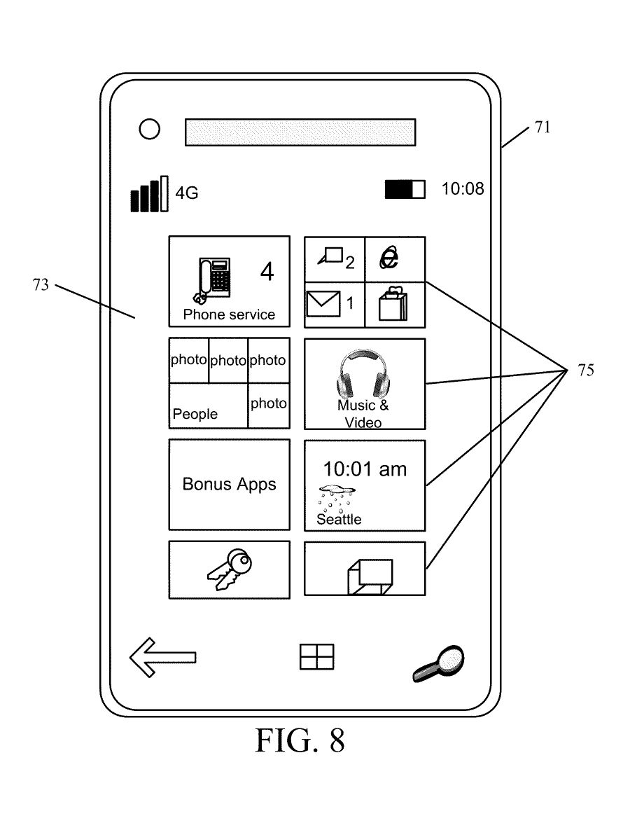

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors/servers 114 from FIG. 1 or those in device 504) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows an example in which the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

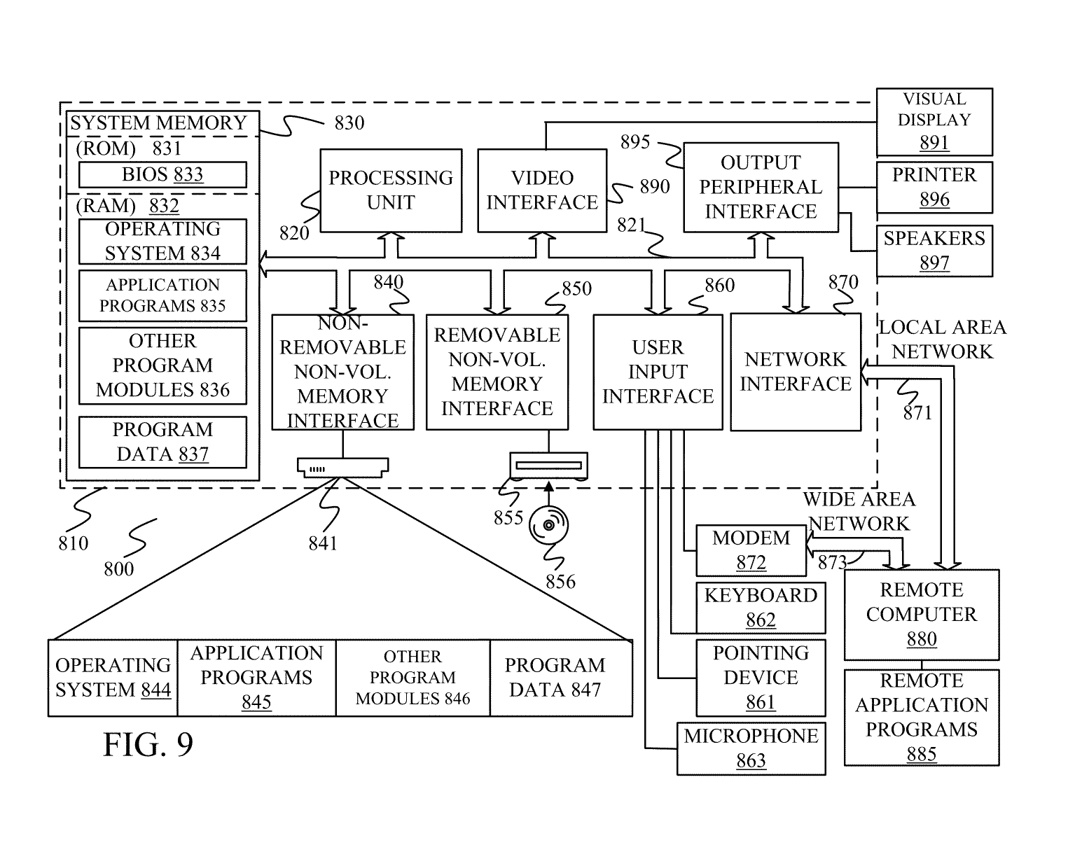

FIG. 9 is one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor/server 114 or those in device 504), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an object identifier component that generates an object selection user input mechanism that is actuated to select a subset of objects from a plurality of objects on a presentation display, the subset of objects having corresponding animations; and

an export format selector component that generates a format selection user input mechanism that is actuated to select an export format for exporting the selected subset of objects and corresponding animations, and that invokes an export format generation engine to generate an export file in the selected export format, the export file including the selected subset of objects and corresponding animations in the selected export format.

Example 2 is the computing system of any or all previous examples and further comprising:

a presentation system that generates slide presentation user input mechanisms that are actuated to generate the presentation display.

Example 3 is the computing system of any or all previous examples wherein the object identifier component and the export format selector component are part of the presentation system.

Example 4 is the computing system of any or all previous examples wherein the export format generation engine comprises:

an internal export format generation engine that is internal to the presentation system.

Example 5 is the computing system of any or all previous examples wherein the export format generation engine comprises:

an external export format generation engine that is external to the presentation system.

Example 6 is the computing system of any or all previous examples wherein the export format generation engine comprises:

a graphics interchange format generator that generates the export file in a graphics interchange format.

Example 7 is the computing system of any or all previous examples wherein the export format generation engine generates additional user input mechanisms that are actuated to specify additional export configuration inputs.

Example 8 is the computing system of any or all previous examples wherein the presentation system comprises a slide presentation system, and wherein the presentation display comprises a slide in a slide presentation generated using the slide presentation system.

Example 9 is a method, comprising:

receiving user selection of a subset of objects on a presentation display, each of the objects in the subset of objects having a corresponding animation;

displaying an export format identification user input mechanism;

receiving actuation of the export format identification user input mechanism identifying an export format; and

generating an export file, in the identified export format, including the selected subset of objects and the corresponding animations.

Example 10 is the method of any or all previous examples wherein generating the export file comprises:

accessing a presentation that includes the presentation display to obtain object information for each of the selected subset of objects, the object information identifying a location of a corresponding object on the presentation display and an animation applied to the corresponding object.

Example 11 is the method of any or all previous examples wherein the presentation comprises a slide presentation and the presentation display comprises a slide within the slide presentation and wherein receiving user selection of a subset of objects comprises:

receiving user selection of the slide presentation within a slide presentation system;

receiving user selection of the slide within the slide presentation; and

displaying the selected slide.

Example 12 is the method of any or all previous examples wherein receiving user selection of a subset of objects comprises:

displaying the objects on the displayed slide as user selectable objects; and

receiving user selection of the subset of objects on the displayed slide.

Example 13 is the method of any or all previous examples wherein receiving user selection of the subset of objects comprises:

receiving user selection of one or more individual objects on the displayed slide; and

selecting the one or more individual objects and corresponding animations for inclusion in the export file.

Example 14 is the method of any or all previous examples wherein receiving user selection of the subset of objects comprises:

receiving a user grouping inputs grouping a plurality of the objects on the slide into a group of objects;

receiving user selection of the group of objects; and

in response, selecting all objects in the group, and corresponding animations, for inclusion in the export file.

Example 15 is the method of any or all previous examples and further comprising:

before displaying the export format identification user input mechanism, displaying an export user input mechanism within the slide presentation system;

receiving user actuation of the export user input mechanism; and

in response, displaying the export format identification user input mechanism.

Example 16 is a slide presentation system, comprising:

a slide generation system that displays slide generation user input mechanisms that are actuated to generate a set of slides in a slide presentation, each slide having a set of selectable objects, a given slide having a given object that has a corresponding animation applied to it;

an object identifier component that displays an object identification user input mechanism that is actuated to select the given object on the given slide for export;

an export format identifier component that generates an export format identification user input mechanism that is actuated to identify an export format for the given object on the given slide; and

an export format generation engine that generates an export file, in the identified export format, including the given object and the corresponding animation.

Example 17 is the slide presentation system of any or all previous examples and further comprising:

an animation identifier component that accesses animation information corresponding to the given object, the animation information identifying a particular animation applied to the given object, the animation identifier component providing the animation information to the export format generation engine.

Example 18 is the slide presentation system of any or all previous examples wherein the export format generation engine comprises:

a graphics interchange format engine that generates the export file in the graphics interchange format.

Example 19 is the slide presentation system of any or all previous examples wherein the export format generation engine comprises:

a video format engine that generates the export file in a video format.

Example 20 is the slide presentation system of any or all previous examples wherein the export format generation engine comprises:

a movie format engine that generates the export file in a movie format.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an object identifier component that generates an object selection user input mechanism that is actuated to select a subset of objects from a plurality of objects on a presentation display, the subset of objects having corresponding animations; and
an export format selector component that generates a format selection user input mechanism that is actuated to select an export format for exporting the selected subset of objects and corresponding animations, and that invokes an export format generation engine to generate an export file in the selected export format, the export file including the selected subset of objects and corresponding animations in the selected export format.

2. The computing system of claim 1 and further comprising:
a presentation system that generates slide presentation user input mechanisms that are actuated to generate the presentation display.

3. The computing system of claim 2 wherein the object identifier component and the export format selector component are part of the presentation system.

4. The computing system of claim 3 wherein the export format generation engine comprises:
an internal export format generation engine that is internal to the presentation system.

5. The computing system of claim 3 wherein the export format generation engine comprises:
an external export format generation engine that is external to the presentation system.

6. The computing system of claim 4 wherein the export format generation engine comprises:
a graphics interchange format generator that generates the export file in a graphics interchange format.

7. The computing system of claim 4 wherein the export format generation engine generates additional user input mechanisms that are actuated to specify additional export configuration inputs.

8. The computing system of claim 4 wherein the presentation system comprises a slide presentation system, and wherein the presentation display comprises a slide in a slide presentation generated using the slide presentation system.

9. A method, comprising:
receiving user selection of a subset of objects on a presentation display, each of the objects in the subset of objects having a corresponding animation;
displaying an export format identification user input mechanism;
receiving actuation of the export format identification user input mechanism identifying an export format; and
generating an export file, in the identified export format, including the selected subset of objects and the corresponding animations.

10. The method of claim 9 wherein generating the export file comprises:
accessing a presentation that includes the presentation display to obtain object information for each of the selected subset of objects, the object information identifying a location of a corresponding object on the presentation display and an animation applied to the corresponding object.

11. The method of claim 10 wherein the presentation comprises a slide presentation and the presentation display comprises a slide within the slide presentation and wherein receiving user selection of a subset of objects comprises:
receiving user selection of the slide presentation within a slide presentation system;
receiving user selection of the slide within the slide presentation; and
displaying the selected slide.

12. The method of claim 11 wherein receiving user selection of a subset of objects comprises:
displaying the objects on the displayed slide as user selectable objects; and
receiving user selection of the subset of objects on the displayed slide.

13. The method of claim 12 wherein receiving user selection of the subset of objects comprises:
receiving user selection of one or more individual objects on the displayed slide; and
selecting the one or more individual objects and corresponding animations for inclusion in the export file.

14. The method of claim 12 wherein receiving user selection of the subset of objects comprises:
receiving a user grouping inputs grouping a plurality of the objects on the slide into a group of objects;
receiving user selection of the group of objects; and
in response, selecting all objects in the group, and corresponding animations, for inclusion in the export file.

15. The method of claim 12 and further comprising:
before displaying the export format identification user input mechanism, displaying an export user input mechanism within the slide presentation system;
receiving user actuation of the export user input mechanism; and
in response, displaying the export format identification user input mechanism.

16. A slide presentation system, comprising:
a slide generation system that displays slide generation user input mechanisms that are actuated to generate a set of slides in a slide presentation, each slide having a set of selectable objects, a given slide having a given object that has a corresponding animation applied to it;
an object identifier component that displays an object identification user input mechanism that is actuated to select the given object on the given slide for export;
an export format identifier component that generates an export format identification user input mechanism that is actuated to identify an export format for the given object on the given slide; and
an export format generation engine that generates an export file, in the identified export format, including the given object and the corresponding animation.

17. The slide presentation system of claim 16 and further comprising:
an animation identifier component that accesses animation information corresponding to the given object, the animation information identifying a particular animation applied to the given object, the animation identifier component providing the animation information to the export format generation engine.

18. The slide presentation system of claim 16 wherein the export format generation engine comprises:
a graphics interchange format engine that generates the export file in the graphics interchange format.

19. The slide presentation system of claim 16 wherein the export format generation engine comprises:
a video format engine that generates the export file in a video format.

20. The slide presentation system of claim 16 wherein the export format generation engine comprises:
a movie format engine that generates the export file in a movie format.
